(19) United States
(12) Patent Application Publication
(10) Pub. No.: US 2026/0216673 A1
(43) Pub. Date: Jul. 30, 2026

(54) APPARATUS AND METHOD OF TRANSFERRING A GAS, LIQUID OR SUBSTANCE INTO ANOTHER GAS OR LIQUID USING MULTIPLE VENTURI INJECTORS IN A SINGLE APPARATUS

(71) Applicant: Gideon William Vandegrift, Sarasota, FL (US)

(72) Inventor: Gideon William Vandegrift, Sarasota, FL (US)

(21) Appl. No.: 19/037,489

(22) Filed: Jan. 27, 2025

Related U.S. Application Data
(60) Provisional application No. 63/603,853, filed on Nov. 29, 2023.

(51) Int. Cl. B01F 25/312

(52) U.S. Cl. CPC B01F 25/31251; B01F 25/31242; B01F 25/31252; B01F 25/31253

(57) ABSTRACT

The present invention is directed towards an apparatus and method of transferring a gas, liquid or substance into another gas or liquid using multiple venturi injectors in a single apparatus. By using multiple venturi chokes, there is less converging restriction and back pressure on the inlet side of the choke areas. This creates a higher outflow pressure on the outflow sides of the chokes. Each of the multiple venturi outlets diverge back together and into the main outflow tube or piping for much better mixing. Multiple venturis help stabilize the suction rate at full suction because you have multiple vacuum ports all multiplying the suction power for a more stable rate.

### CROSS-REFERENCE TO RELATED APPLICATION

This application claims the benefit of priority of U.S. provisional application No. 63/603,853, filed Nov. 29, 2023, the contents of which are herein incorporated by reference.

### BACKGROUND OF THE INVENTION

Conventional single venturi injectors have lower and unstable fluctuating vacuum suction rates. They also lose outflow pressure because of converging a tube down into a single smaller choke area which creates a pressure difference on each side. This lowers the pressure greatly on the outflow side and greatly increases back pressure on pumps on the inflow side. A single venturi design also does not mix very well because the diverging side of the choke is a single divergence, and the gas or liquids shoot straight out without multiple collision points.

Conventional single venturi injector designs also decrease outflow pressure by constricting to a small choke point. Such designs also exhibit a low suction rate because of only one choke point and one vacuum suction port. Conventional single venturis do not mix very well because there is only one divergence from the choke point, and it just shoots straight out into a pipe or tube instead of colliding and creating collisions.

The present invention is directed at overcoming these and other shortcomings in convention single venturi designs. In a preferred embodiment, the present invention is directed at using multiple venturi chokes, thereby providing less converging restriction and back pressure on the inlet side of the choke areas. Such an improved design creates a higher outflow pressure on the outflow sides of the chokes.

As described in more detail below, each of the multiple venturi outlets diverge back together and into the main outflow tube or piping for much better mixing. In addition, using multiple venturis as contemplated in the present invention can help stabilize the suction rate at full suction because multiple vacuum ports all multiplying the suction power provides for a more stable rate.

### SUMMARY OF THE INVENTION

In one aspect of the present invention, there is disclosed an improved venturi injector design directed towards using a plurality of multiple venturis to increase the suction rate over a single venturi by using multiple chokes and choke vacuum inlets. Such a design also stabilizes the vacuum suction rate by using multiple chokes and choke vacuum inlets.

In one aspect of the present invention, there is disclosed a single pipe that converges into multiple venturi constrictions. Those restrictions come to multiple choke points. Each choke point then connects to an inflow vacuum suction port. Then each choke point diverges back into an area that connects to a single tube or pipe.

These and other features, aspects and advantages of the present invention will become better understood with reference to the following drawings, description and claims.

### BRIEF DESCRIPTION OF THE DRAWINGS

FIG. 1A is a front view of a pipe comprising multiple venturi injectors in accordance with a preferred embodiment of the present invention;

FIG. 1B is a top view of the pipe of FIG. 1A;

FIG. 2A is a left side perspective view of the pipe of FIG. 1;

FIG. 2B is a left side view of the pipe of FIG. 1;

FIG. 3A is a right side perspective view of the pipe of FIG. 1;

FIG. 3B is a right side view of the pipe of FIG. 1;

FIG. 4A is a cross sectional front view of the pipe of FIG. 1;

FIG. 4B is a cross sectional top view of the pipe of FIG. 1;

FIG. 5 is a left side cross sectional view of the pipe of FIG. 1;

FIG. 6A is a left side view of the pipe of FIG. 1;

FIG. 6B is a left side perspective view of the pipe of FIG. 1;

FIG. 7 is a right side view of the pipe of FIG. 1;

FIG. 8A is a cross sectional view of the pipe of FIG. 1;

FIG. 8B is a cross sectional perspective view of the pipe of FIG. 1;

FIG. 9A is a cross sectional view of a pipe constructed in accordance with an alternative embodiment of the present invention;

FIG. 9B is a cross sectional perspective view of the pipe of FIG. 9A;

FIG. 10A is a cross sectional view of a pipe constructed in accordance with an alternative embodiment of the present invention;

FIG. 10B is a cross sectional perspective view of the pipe of FIG. 10A.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

As described above, conventional single venturi injectors have lower and unstable fluctuating vacuum suction rates. They also lose outflow pressure because of converging a tube down into a single smaller choke area which creates a pressure difference on each side. This lowers the pressure greatly on the outflow side and greatly increases back pressure on pumps on the inflow side. A single venturi does not mix very well because the diverging side of the choke is a single divergence, and the gas or liquids shoot straight out without multiple collision points. The present invention claimed here solves these and other problems with conventional venturi injectors.

In a preferred embodiment, the present invention is directed towards using a plurality of multiple venturis to increase the suction rate over a single venturi by using multiple chokes and choke vacuum inlets. Such a design also stabilizes the vacuum suction rate by using multiple chokes and choke vacuum inlets.

By using multiple venturis, the area of the combined multiple venturi chokes is increased, providing a higher outflow pressure because there is less constriction inside of the venturi. Using multiple venturi chokes also allows more liquid though because there is more area for it to pass through. This means less back pressure on pumps and creates a higher outflow pressure while also increasing suction rate. In addition, such a design provides for improved mixing of the gases and liquids because using multiple venturis that collide through multiple divergences provides for mass transferring and mixing into a liquid. This also achieves better mixing of gases and liquids through multiple venturi divergences and collision contact points as they diverge back into a single connected pipe or tube.

The present invention achieves both a higher and more stable rate of vacuum suction, while simultaneously keeping the outflow pressure high. Existing single venturi injectors lose outflow pressure as you converge down to a single choke point. Through multi divergent venturi collisions, this new type of venturi achieves far greater mixing of liquids and gases entering into an outflow pipe or tube.

Conventional single venturi injectors do not exhibit a stable reading on a flow meter device unless the suction rate is reduced significantly. This in turn makes it more difficult to correctly get a reading on flow rate when the vacuum port is fully open. A typical single venturi will always lose outflow pressure by the single choke point which can be a problem if you want to keep outflow pressure high like in irrigation water treatment and wastewater treatment piping.

By using multiple venturi chokes as described herein and as shown in the accompanying drawings, there is less converging restriction and back pressure on the inlet side of the choke areas. This creates a higher outflow pressure on the outflow sides of the chokes. All of the multiple venturi outlets diverge back together and into the main outflow tube or piping for much better mixing. Multiple venturis help stabilize the suction rate at full suction because you have multiple vacuum ports all multiplying the suction power for a more stable rate.

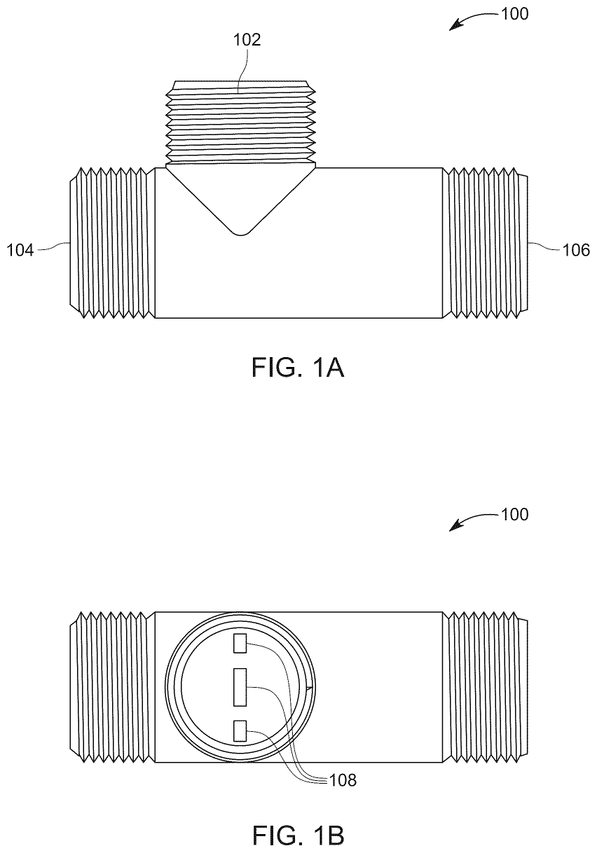

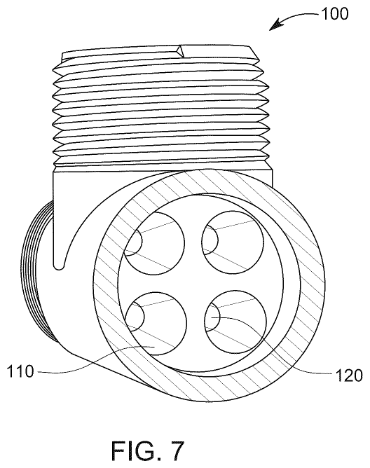

As discussed herein and as shown in the accompanying FIGS. 1-10, in a broad sense the present invention comprises:
1) A single inflow tube that converges into multiple venturi chokes which each connect to a suction inlet port;
2) Multiple inlet ports that diverge into multiple diverging venturi outlets;
3) The vacuum inlet port enters from the top of the device and then connects into multiple ports on multiple chokes; and
4) Multiple diverging venturis then enter back into a single tube or piping where multiple directional collisions take place for better mixing of gases and liquids.

As seen in FIGS. 1-10, in a broad sense the present invention is directed at a single pipe that converges into multiple venturi constrictions. Those restrictions come to multiple choke points. Each choke point then connects to an inflow vacuum suction port. Then each choke point diverges back into an area that connects to a single tube or pipe.

FIGS. 1-7 depict a pipe constructed in accordance with a preferred embodiment of the present invention wherein multiple suction port channels connect on each side of a choke creating multiple choke port inlets for each venturi.

FIGS. 1A and 1B show side and top views of a pipe 100 constructed in accordance with a preferred embodiment of the present invention. Pipe 100 comprises vacuum/suction port 102, inflow 104 and outflow/mixing chamber 106. As seen in FIG. 1B, vacuum/suction port 102 includes three vacuum suction channels 108.

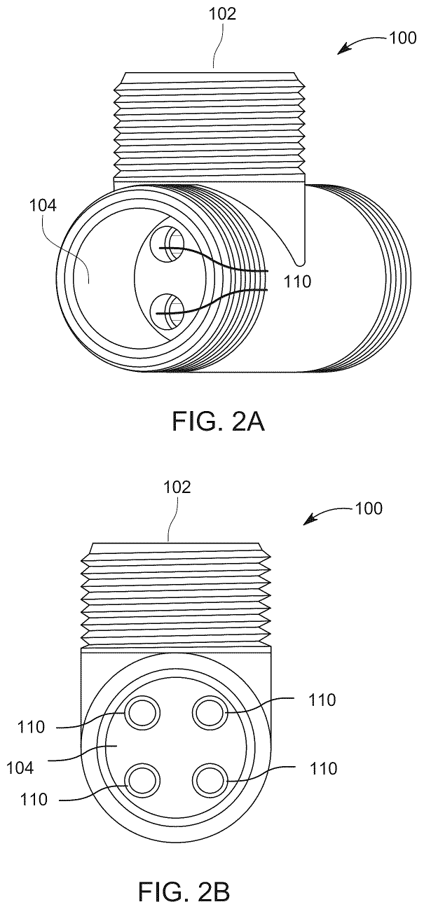

FIG. 2A shows a perspective view of inflow 104 of pipe 100, and FIG. 2B shows a side view of inflow 104. As seen in FIGS. 2A and 2B, inflow 104 comprises four choke port inlets 110.

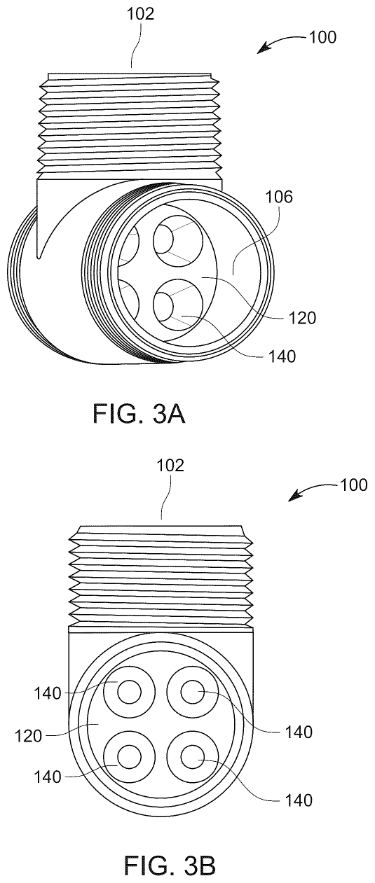

FIG. 3A shows a perspective view of outflow/mixing chamber 106 of pipe 100, and FIG. 3B shows a side view of outflow/mixing chamber 106. As seen in FIGS. 3A and 3B, outflow/mixing chamber 106 comprises four diverging venturi outlets 140.

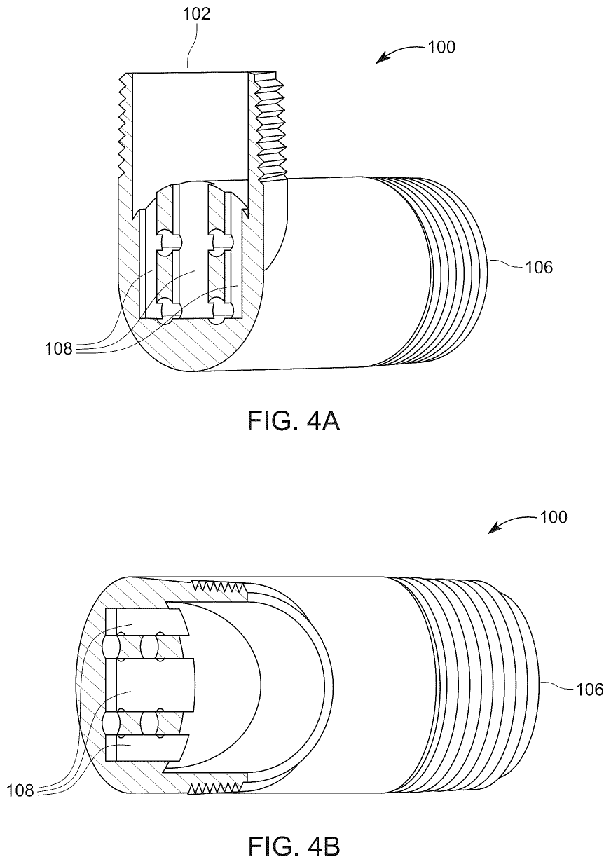

FIG. 4A shows a cross-sectional perspective view of vacuum/suction port 102 of pipe 100, and FIG. 4B shows an exploded cross-sectional perspective view of vacuum/suction port 102. As seen in FIGS. 4A and 4B, vacuum/suction port 102 comprises three vacuum suction channels 108.

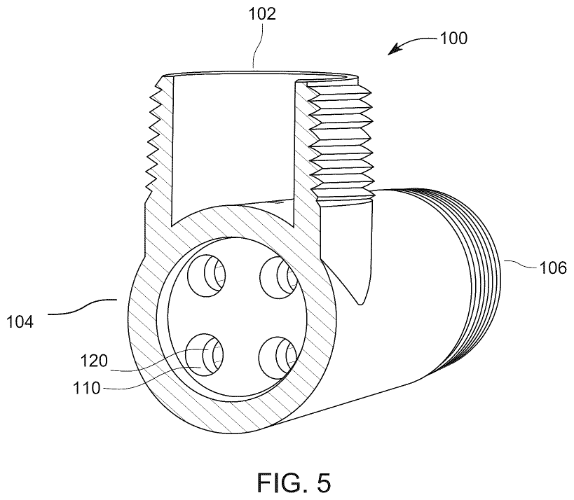

FIG. 5 shows a cross-sectional perspective view of inflow 104 of pipe 100. As seen in FIG. 5, inflow 104 comprises four converging inlet chokes 110 which each comprise choke port inlets 120.

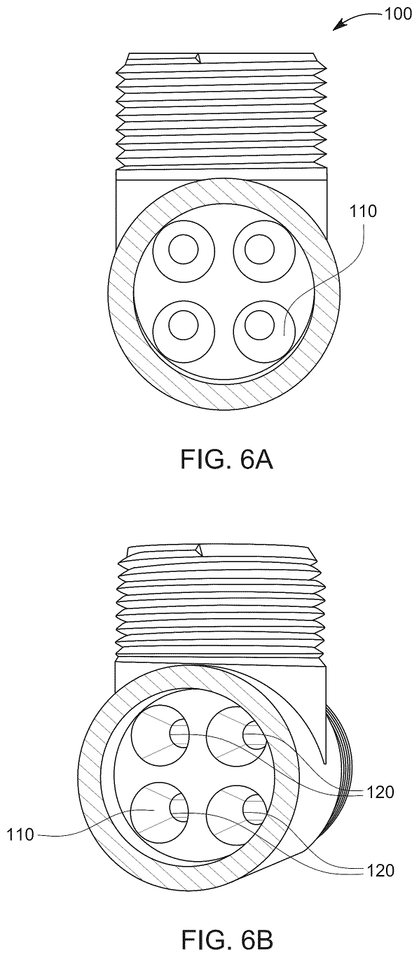

FIG. 6A shows a side cross-sectional view of inflow 104 of pipe 100, and FIG. 6B shows a cross-sectional perspective side view of inflow 104. As seen in FIGS. 6A and 6B, inflow 104 comprises four converging inlet chokes 110 which each comprise choke port inlets 120.

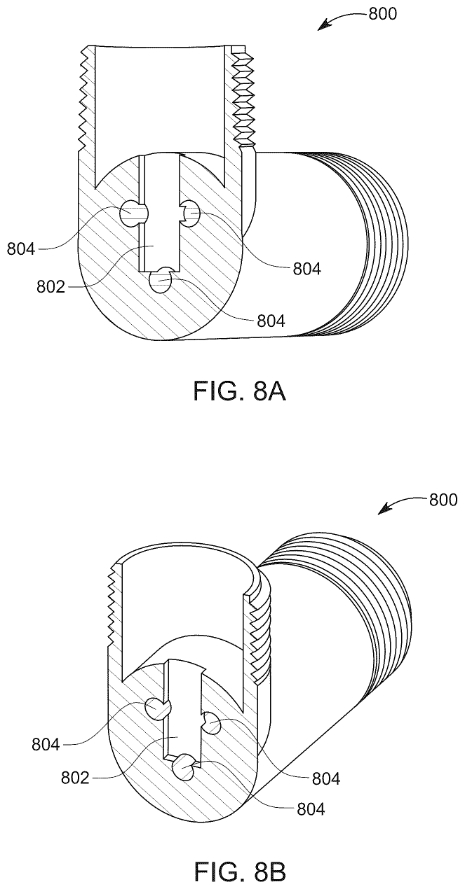

FIGS. 8-10 depict cross-sectional views of pipes constructed in accordance with preferred embodiments of the present invention including examples of multiple venturis and multiple vacuum suction ports.

FIGS. 8A and 8B show a side cross-sectional perspective view of pipe 800 having three venturis 804 with a single vacuum inlet port 802 for each venturi.

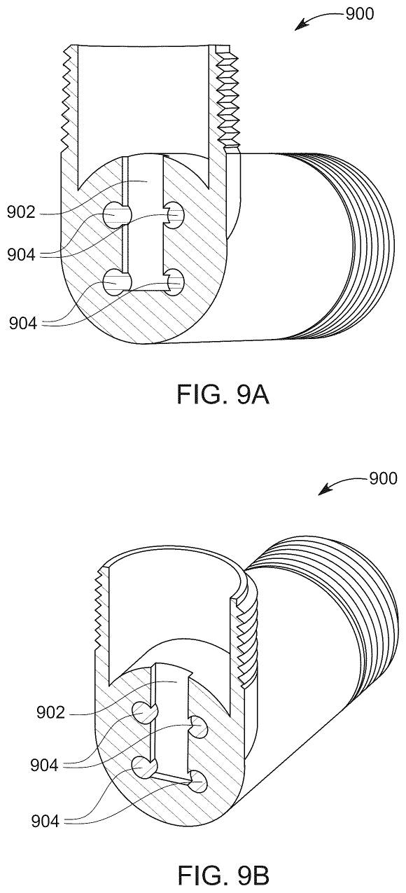

FIGS. 9A and 9B show a side cross-sectional perspective view of pipe 900 having four venturis 904 with a single vacuum inlet port 902 for each venturi.

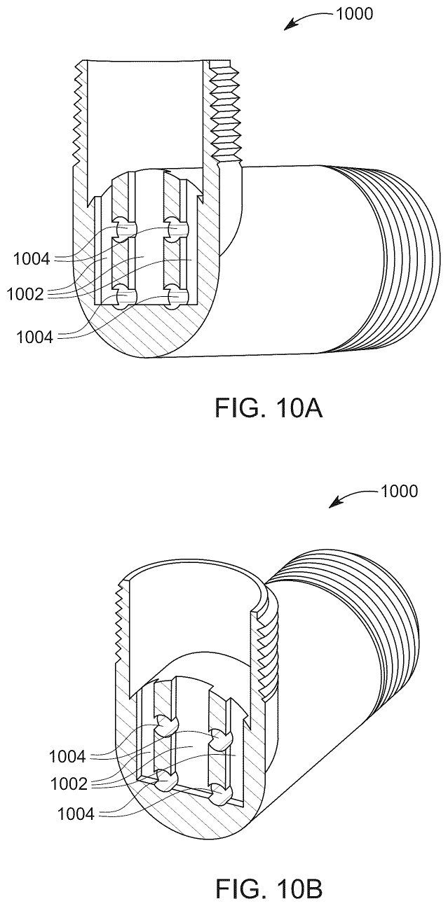

FIGS. 10A and 10B show a side cross-sectional perspective view of pipe 1000 having four venturis 1004 with multiple vacuum inlet ports 1002 for each venturi. Vacuum inlet ports 1002 create a vacuum channel at a choke on each side creating multiple vacuum ports on each side of a venturi.

A gas or a liquid enters though a single tube or pipe. That single tube or pipe then splits into multiple smaller venturis that all individually converge into their own choke point. As the gas or liquid increases pressure through each choke, it creates a suction through a choke point vacuum inlet port. Each venturi choke has its own vacuum port that all connect together through the middle of the device. This gas or liquid can be delivered into each individual choke at the same time and rate of flow. After the suction vacuum port suctions in the gas or liquid, it then diverges in into the multiple venturi outflow tubes. These multiple outflow tubes then all open back up into a single tube or pipe where they all flow and mix back together by way of multiple diverging collision.

The air suction port needs to come from the top and split right down the middle between all of the venturis so it connects to each choke. A port could also be added on each left and right side to provide each venturi choke two total suction port connections.

The device of the present invention can be attached to the outflow of any pump that delivers liquid or gas. It will have a higher outflow pressure and solves the lowering of outflow pressure that a single venturi creates. The present invention could be used for wastewater treatment, oxygen injection, ozone injection, clean water drinking treatment, aquarium aeration, hydroponics aeration, fish farming, wine aeration, fertilizer and irrigation, pool and spa and ponds aeration, to name a few.

It should be understood, of course, that the foregoing relates to exemplary embodiments of the invention and that modifications may be made without departing from the spirit and scope of the invention as set forth in the following claims.

What is claimed is:

1. A pipe comprising an inflow port, an outflow port and a suction port, wherein the suction port comprises a first suction channel connected to at least a first and second choke port inlet within the inflow port, and further connect to at least a first and second venturi outlet port within the outflow port.

2. The pipe of claim 1, wherein the first suction port channel connects to a first, a second and a third choke port inlet and a first, a second and a third venturi outlet port.

3. The pipe of claim 1, wherein the first suction port channel connects to a first, a second, a third and a fourth choke port inlet and a first, a second, a third and a fourth venturi outlet port.

4. The pipe of claim 1, further comprising a second and a third suction channel within the suction port, and wherein the first suction channel connects to a first and a second choke port inlet, and wherein the second suction channel connects to the first and the second choke port inlets and also connects to a third and a fourth choke port inlet, and wherein the third suction channel connects to the third and the fourth choke port inlets.

5. A pipe comprising a single inflow tube that converges into multiple venturi chokes which each connect to a suction inlet port, and further comprising multiple inlet ports that diverge into multiple diverging venturi outlets, and wherein multiple diverging venturis then enter back into a single tube or piping where multiple directional collisions take place for better mixing of gases and liquids.

6. A pipe that converges into multiple venturi constrictions that connect to multiple choke points, wherein each choke point then connects to an inflow vacuum suction port, and wherein each choke point diverges back into an area that connects to a single tube or pipe.
